(19) United States
(12) Patent Application Publication
(10) Pub. No.: US 2017/0008675 A1
(43) Pub. Date: Jan. 12, 2017

(54) GUSSET BAG, METHOD FOR MANUFACTURING GUSSET BAG, AND METHOD FOR JOINING LAMINATED MEMBERS

(71) Applicant: HOSOKAWA YOKO CO., LTD., Tokyo (JP)

(72) Inventors: Kazuhiro UMENAKA, Tokyo (JP); Akio YOTO, Tokyo (JP)

(73) Assignee: HOSOKAWA YOKO CO., LTD., Tokyo (JP)

(21) Appl. No.: 15/113,232

(22) PCT Filed: Jan. 23, 2015
(86) PCT No.: PCT/JP2015/051934

§ 371 Date: Jul. 21, 2016

(30) Foreign Application Priority Data
Jan. 24, 2014 (JP) 2014-011320

(51) Int. Cl. B65D 30/20; B31B 29/60; B65D 75/00

(52) U.S. Cl. CPC B65D 31/10; B65D 75/008; B31B 29/60; B31B 2221/20; B31B 2221/50; B31B 2219/60

(57) ABSTRACT

A gusset bag is formed of a pair of flat surface parts facing each other, and side gusset parts folded to the inside of the bag. The gusset bag has side heat-sealing portions at which the sides of the flat surface part and sides of the side gusset parts are joined at the inner surfaces thereof, side heat-sealing portions at which the sides of the flat surface part and the other sides of the side gusset parts are joined at the inner surfaces thereof, and closing sealing portions at which the side heat-sealing portions and the side heat-sealing portions are joined at the outer surfaces of the side gusset parts by ultrasonic sealing. With this configuration, in the gusset bag, it is possible to easily close the gusset parts, while preventing film pieces or dust from entering the bag in a step of closing the gusset parts.

### TECHNICAL FIELD

The present invention relates to a gusset bag, a method for manufacturing the gusset bag, and a method for joining laminated members.

### BACKGROUND ART

A bag is formed of, for example, a laminated film composed of a sealant layer having a heat-sealing property and a base layer having heat resistance, which are laminated on each other. The sealant layer constitutes the inner surface of the bag, and the base layer constitutes the outer surface of the bag.

Examples of a method for joining together laminated films to form a bag include: a method using external heating, in which heat applied by a heat source located on the outside of the laminated film gradually advances from the surface to the inside of the laminated film through heat conduction, radiation, convection, etc.; and a method using internal heating, in which the laminated film is heated simultaneously from inside and outside by self-heating. Examples of the method using external heating include methods using hot plate sealing (hereinbelow, also referred to as simply “heat seal”), impulse sealing, etc., and examples of the method using internal heating include methods using high-frequency sealing, ultrasonic sealing, etc.

In ultrasonic sealing, which is a method using internal heating, laminated films are instantly fused and joined together by using frictional heat, generated by fine ultrasonic vibration, and applying pressure. In ultrasonic sealing, the laminated films are made to rub against each other by the ultrasonic vibration and may produce dust. As a result, the produced dust may enter the bag as foreign matter.

Furthermore, as shown in FIG. 12, a gusset bag 100 includes a pair of flat surface parts 102A and 102B facing each other, and side gusset parts 104 provided at the sides of the flat surface parts 102A and 102B. In the gusset bag 100, inner surface layers 106 are sealant layers having a heat-sealing property, and outer surface layers 108 are base layers having heat resistance.

Therefore, as shown in FIG. 13, even when an end-opening sealing portion 110 is formed by, for example, heat sealing to close the upper parts or the lower part of the flat surface parts 102A and 102B, the outer surface layers 108 of the opposed side gusset parts 104 are not joined together at side portions 110A of the end-opening sealing portion 110. As a result, the upper parts or the lower parts of the side gusset parts 104 are open. In such a state, the appearance of the gusset bag 100 is unsatisfactory.

Furthermore, in a state in which the side gusset parts 104 are open, stress is most likely to be concentrated on intersection points 110B, at which the boundary between the end-opening sealing portion 110 and a content storage portion meets folded portions of the side gusset parts 104. Therefore, if the gusset bag 100 is dropped by accident, the gusset bag 100 may rupture from the intersection points 110B, on which the stress is concentrated.

To counter this situation, as shown in FIG. 14, a gusset bag 100 in which the side portions 110A of the end-opening sealing portion 110, which are the upper ends of the side gusset parts 104, are joined to close the open side gusset parts 104 has been developed. This configuration improves the appearance of the gusset bag 100 and prevents rupturing of the bag.

As an example technique for closing open side gusset parts like this, PTL 1 discloses a gusset bag in which through-holes are provided by removing portions of laminated films in side gusset parts, and the inner surface layers of a pair of flat surface parts are joined together via the through-holes, thereby integrating the pair of flat surface parts.

However, in such a gusset bag 100, small film pieces produced by cutting to provide the through-holes may enter the gusset bag 100, or such film pieces may be transported to the subsequent step, causing a sealing fault.

Furthermore, FIG. 15 shows the lower part of a gusset bag 120 having a bottom gusset part 112, in which FIG. 15(A) is a front view of the gusset bag 120, and FIG. 15(B) is a perspective view of the bottom gusset part 112. The hatched section is a section in which the laminated films constituting the gusset bag 120 are joined.

In the bottom gusset part 112, because the outer surface layer 108, which constitutes the outer surface when joined to the pair of flat surface parts 102A and 102B, is formed of the base layer having heat resistance, normally, areas of the outer surface layer 108 are not joined together.

To counter this situation, by cutting away portions of side portions of the bottom gusset part 112, the inner surface layers 106 of the flat surface parts 102A and 102B are joined together via the cut-away portions 112A, when the bottom gusset part 112 is joined to the flat surface parts 102A and 102B. With this configuration, the pair of flat surface parts 102A and 102B are integrated, the bottom of the gusset bag 120 is prevented from opening at the sides, and a free-standing function of the gusset bag 120 is achieved.

However, in this gusset bag 120, small film pieces produced by cutting to provide the cut-away portions 112A may enter the gusset bag 120, or such film pieces may be transported to the subsequent step, causing a sealing fault.

In the gusset bags (side gusset bags and bottom gusset bags) described above, if the flat surface parts and gusset parts constituting the gusset bag are separate members, the positions of the through-holes, described in PTL 1, may be easily aligned in the process of manufacturing the gusset bag. However, in some gusset bags, the flat surface parts and the gusset parts are formed of a single laminated film, and these parts are formed by folding the laminated film. In the case of such a gusset bag, providing through-holes in the gusset parts makes the manufacturing process complicated. Furthermore, because the gusset parts are formed by folding a single laminated film, the positions of the through-holes may not be aligned, and providing through-holes at aligned positions in the gusset parts itself has been difficult.

To counter this situation, PTL 2 discloses a free-standing wrapping bag having a bottom gusset part. In this bag, two cutting lines are provided in a bottom member, a belt-like part between the two cutting lines is folded so as to be positioned in an unsealed portion in a vessel-bottom-shaped sealing portion, and a front-side film and a rear-side film, constituting two main films, are sealed at the position where the belt-like part was before being folded. Thus, the bottom gusset of the wrapping bag does not open, and the bag can maintain a free-standing property.

### CITATION LIST

### Patent Literature

{PTL 1} Japanese Unexamined Utility Model Application, Publication No. Hei 2-120342
{PTL 2} Japanese Unexamined Patent Application, Publication No. 2009-90987

### SUMMARY OF INVENTION

### Technical Problem

However, also in the free-standing wrapping bag disclosed in PTL 2, if the two cutting lines are provided in an intersecting manner, not parallel to each other, the cutting lines form a cut-away portion, and a film piece separated from the bag may enter the gusset bag. Furthermore, because the belt-like part formed between the two cutting lines is folded so as to be positioned in the unsealed portion in the vessel-bottom-shaped sealing portion, concavo-convex portions appear on the surface, making the appearance unsatisfactory. Moreover, if the cutting lines extend, the gusset bag may be seriously torn.

The present invention has been made in view of these circumstances, and an object thereof is to provide a gusset bag, a method for manufacturing the gusset bag, and a method for joining laminated members in which the gusset part can be easily closed, while preventing the entry of film pieces or dust in the bag in a step of closing a gusset part.

### Solution to Problem

To solve the above-described problems, a gusset bag, a method for manufacturing the gusset bag, and a method for joining laminated members of the present invention provide the following solutions.

A gusset bag according to a first aspect of the present invention includes: a pair of flat surface parts facing each other; a gusset part that is folded to the inside of the bag; a first joint portion at which a side of one flat surface part and a side of the gusset part are joined at the inner surfaces thereof; a second joint portion at which a side of the other flat surface part and the other side of the gusset part are joined at the inner surfaces thereof; and a third joint portion at which the first joint portion and the second joint portion are joined together at the outer surface of the gusset part by ultrasonic sealing.

The gusset bag according to this configuration includes the pair of flat surface parts facing each other and the gusset part that is folded to the inside of the bag.

A side of one flat surface part and a side of the gusset part are joined at the inner surfaces thereof at the first joint portion. Furthermore, a side of the other flat surface part and the other side of the gusset are joined at the inner surfaces thereof at the second joint portion. The first joint portion and the second joint portion are joined together by, for example, heat sealing. Although the first joint portion and the second joint portion are not limited to heat sealing, because the inner surfaces are joined together, if, for example, joining by ultrasonic sealing is performed, dust produced by rubbing between the laminated films, caused by ultrasonic vibration, may enter the bag, which is undesirable.

Furthermore, the first joint portion and the second joint portion are joined together at the outer surface of the gusset part, at the third joint portion. If joining at the third joint portion is not performed, the gusset part is not closed at the outer surface and is open. By performing joining at the third joint portion on the gusset part, the open gusset part is closed. The joining at the third joint portion is performed, for example, in the vicinity of the ends of the gusset bag.

The joining at the third joint portion is performed by ultrasonic sealing. If the outer surface of the gusset part has heat resistance, when external heating, such as heat sealing, is performed, the film of the inner surface fuses before the film of the outer surface fuses. Therefore, if the outer surface is to be fused, almost all the laminated film fuses, and hence, joining by external heating is not suitable.

As has been described above, in joining by ultrasonic sealing, dust may be produced because the two surfaces to be joined together are caused to rub against each other by friction. However, joining at the third joint portion is performed on the outer surface of the gusset part, and, even when dust is produced by rubbing against each other, this portion is outside the gusset bag. Therefore, even if dust is produced, the dust does not enter the gusset bag. Because joining at the first joint portion and the second joint portion, which are inside the bag, is already performed, these portions do not rub against each other when joining at the third joint portion is performed.

Accordingly, with this configuration, it is possible to easily close the gusset part, while preventing film pieces or dust from entering the bag in the step of closing the gusset part.

In the first aspect, it is desirable that the pair of flat surface parts and the gusset part be formed by folding a film into sections.

In this configuration, the flat surface parts and the gusset part are formed by folding a film into sections, and it is possible to easily close the gusset part, while preventing film pieces or dust from entering the bag in the step of closing the gusset part. Moreover, because the flat surface parts and the gusset part are sectioned by folding the film, stiff side heat-sealing portions are not formed at a part held by the user's hand. Thus, the pain felt when holding the bag by hand is reduced.

In the first aspect, it is desirable that the pair of flat surface parts be each formed of a single film, and the gusset part be formed of a single film.

In this configuration, the pair of flat surface parts and the gusset part are formed of different films and are joined in the process of forming the gusset bag. Thus, it is possible to easily close the gusset par, while preventing film pieces or dust from entering the bag in the step of closing the gusset part. Furthermore, because the side heat-sealing portions for joining the flat surface parts and the gusset part serve as the first joint portion and the second joint portion, there is no need to separately provide the first joint portion and the second joint portion.

In the first aspect, it is desirable that the gusset part be a side gusset part or a bottom gusset part.

In this configuration, regardless of the position of the gusset part, it is possible to easily close the gusset part, while preventing film pieces or dust from entering the bag in the step of closing the gusset part.

In the first aspect, it is desirable that a concavo-convex pattern be formed on a joining surface of the third joint portion.

In this configuration, owing to the concavo-convex pattern formed on the joining surface of the third joint portion, the joining strength achieved by the third joint portion can be increased.

A method for manufacturing a gusset bag having a pair of flat surface parts facing each other and a gusset part folded to the inside of the bag, the method according to a second aspect of the present invention includes: joining a side of one flat surface part and a side of the gusset part at the inner surfaces thereof at a first joint portion; joining a side of the other flat surface part and the other side of the gusset part at the inner surfaces thereof at a second joint portion; and forming a third joint portion by joining the first joint portion and the second joint portion at the outer surface of the gusset part by ultrasonic sealing.

A method for joining laminated members each formed by laminating a first layer having a heat-sealing property and a second layer having heat resistance, in which the second layers are joined together, the method according to a third aspect of the present invention includes: joining the first layers at a first joint portion; joining the first layers at a second joint portion in a different area from the first joint portion, and joining the first joint portion and the second joint portion at the second layers thereof by ultrasonic sealing, forming a third joint portion.

### Advantageous Effects of Invention

The present invention has an excellent advantage that it is possible to easily close the gusset part, while preventing film pieces or dust from entering the bag in the step of closing the gusset part. Therefore, in the case of a gusset bag having side gusset parts, it is possible to improve the appearance and to prevent rupturing of the bag when the gusset bag is dropped by accident, whereas in the case of a gusset bag having a bottom gusset part, it is possible to improve a free-standing property.

### BRIEF DESCRIPTION OF DRAWINGS

FIG. 1 is a perspective view showing the upper part of a gusset bag according to a first embodiment of the present invention.

FIG. 2 is a lateral cross-sectional view showing, in a partially enlarged state, side heat-sealing portions according to the first embodiment of the present invention.

FIG. 3 is a perspective view showing the upper part of the gusset bag according to the first embodiment of the present invention, in which the side heat-sealing portions are formed in side gusset parts.

FIG. 4 is a lateral cross-sectional view showing an example joining step for joining laminated films by ultrasonic sealing.

FIG. 5 is a lateral cross-sectional view showing, in a partially enlarged state, the side heat-sealing portions according to the first embodiment of the present invention.

FIG. 6 is a perspective view showing the upper part of a gusset bag according to the first embodiment of the present invention in which the respective parts are formed of different laminated films.

FIG. 7 is a lateral cross-sectional view showing, in a partially enlarged state, side heat-sealing portions according to the first embodiment of the present invention in which the respective parts are formed of different laminated films.

FIG. 8 is a perspective view showing the upper part of a gusset bag according to another example of the first embodiment of the present invention.

FIG. 9 is a front view showing the lower part of a gusset bag according to a second embodiment of the present invention.

FIG. 10 is a perspective view showing the upper part of a gusset bag according to a third embodiment of the present invention, in which side heat-sealing portions are formed in side gusset parts.

FIG. 11 is a lateral cross-sectional view showing, in a partially enlarged state, the side heat-sealing portions according to the third embodiment of the present invention.

FIG. 12 is a perspective view showing the upper part of a gusset bag having side gusset parts.

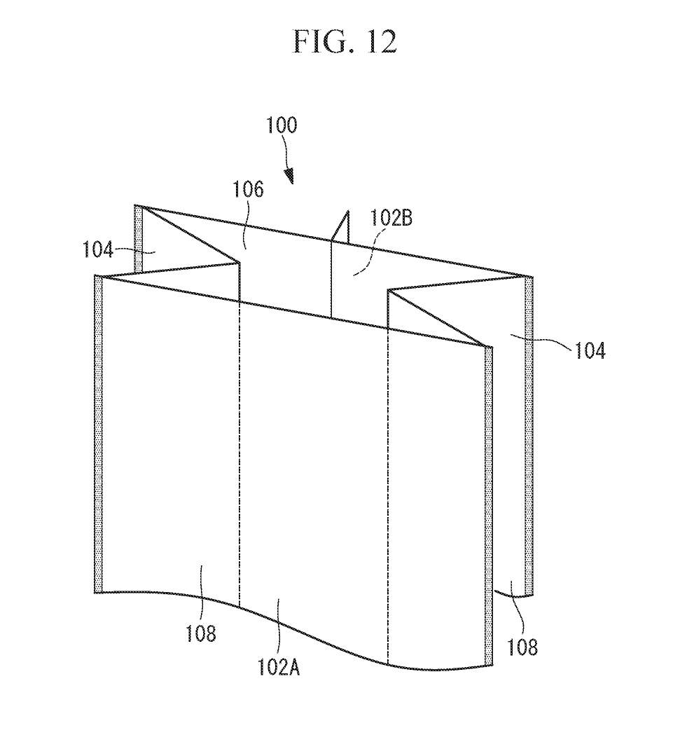

FIG. 13 is a perspective view showing the upper part of a gusset bag, in which upper parts of side gusset parts are open.

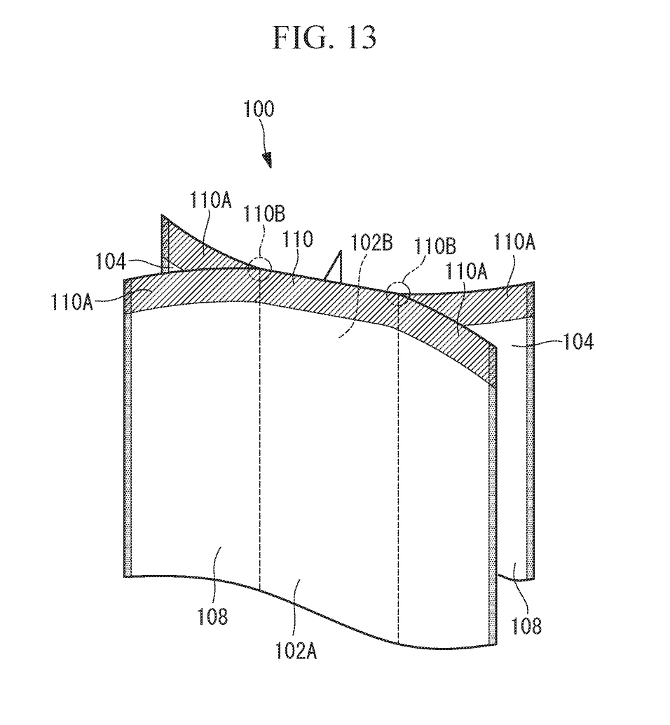

FIG. 14 is a perspective view showing the upper part of a gusset bag in which open side gusset parts are closed.

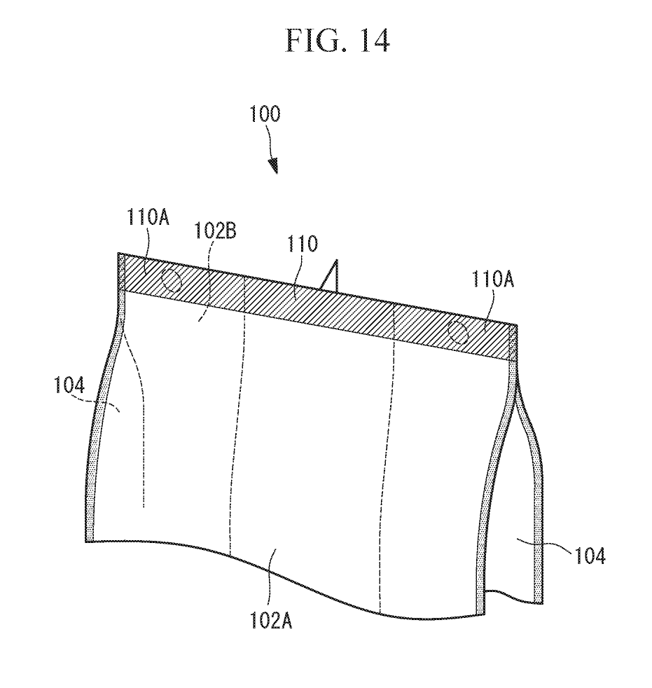

FIG. 15 shows the lower part of a gusset bag having a bottom gusset part, in which (A) is a front view and (B) is a perspective view of the bottom gusset part.

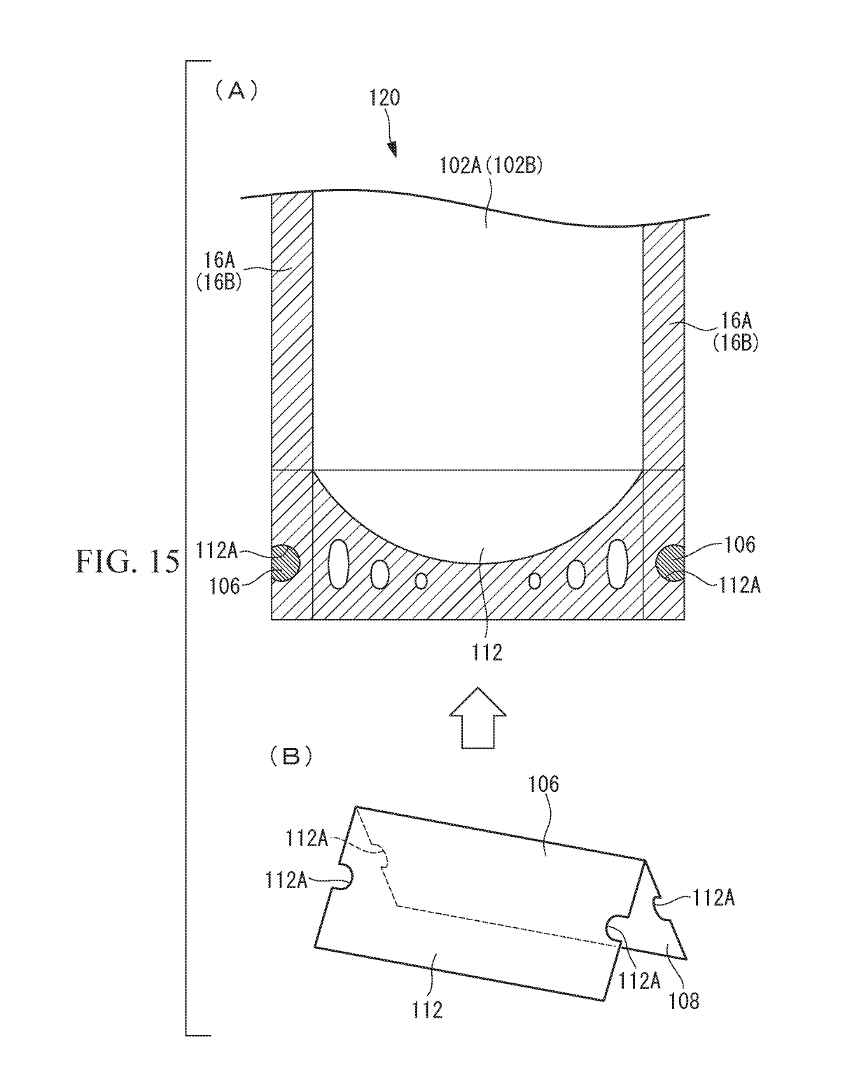

### DESCRIPTION OF EMBODIMENTS

An embodiment of a gusset bag, a method for manufacturing the gusset bag, and a method for joining laminated members of the present invention will be described below with reference to the drawings.

### First Embodiment

A first embodiment of the present invention will be described below.

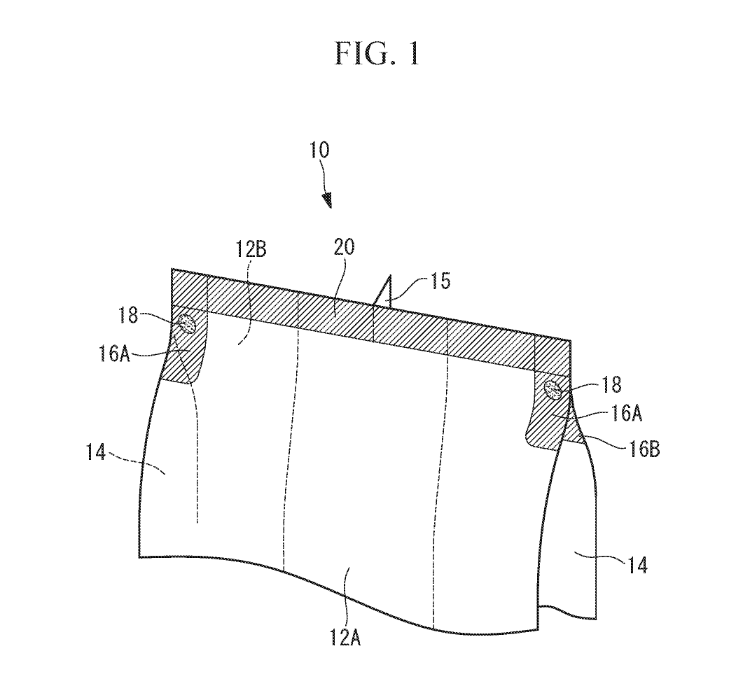

A gusset bag 10 according to the first embodiment, shown in FIG. 1, is a bag having gusset parts in the sides. The gusset bag 10 includes a pair of flat surface parts 12A and 12B facing each other, and side gusset parts 14 provided at the sides of the flat surface parts 12A and 12B and folded, in the form of gusset parts at the sides, to the inside of the bag.

The pair of flat surface parts 12A and 12B and the pair of side gusset parts 14 are formed of a single laminated film 21, which is a film-like laminated member that is composed of resin or the like and has a multilayer structure. More specifically, in the gusset bag 10 according to the first embodiment, the flat surface parts 12A and 12B and the side gusset parts 14 are formed by folding the laminated film 21 at predetermined positions. Furthermore, the inner surfaces at the ends of the rectangular laminated film 21, from which the flat surface parts 12A and 12B and the pair of side gusset parts 14 are formed, are joined together, forming a back-closure heat sealing portion 15.

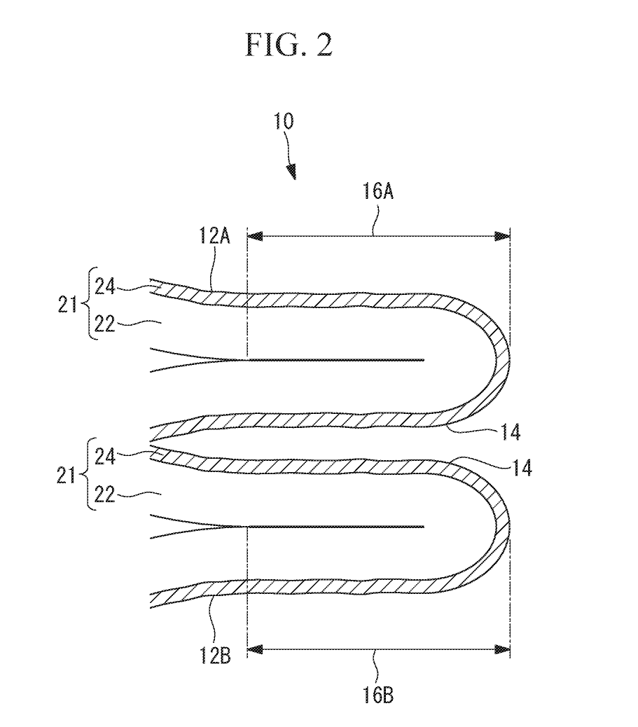

As shown in FIG. 2, the laminated film 21 includes an inner surface layer 22 having a heat-sealing property and an outer surface layer 24 having heat resistance. The inner surface layer 22 is a sealant layer, and the outer surface layer 24 is a base layer.

The melting point of the resin constituting the inner surface layer 22 is, for example, 170° C. or less, and the melting point of the resin constituting the outer surface layer 24 is higher than the melting point of the resin constituting the inner surface layer 22 and is, for example, 250° C. or more. Furthermore, a functional layer, serving as an intermediate layer, may be disposed between the inner surface layer 22 and the outer surface layer 24, if necessary.

An example of the film used as the inner surface layer 22 is an unoriented film composed of a polyolefin resin, such as polypropylene or polyethylene, including low-density polyethylene, medium-density polyethylene, high-density polyethylene, and linear low-density polyethylene; a mixture of these resins; an ionomer resin; and at least one copolymer selected from a group consisting of ethylene-vinyl acetate copolymer, ethylene-acrylate copolymer, ethylene-methyl acrylate copolymer, and ethylene-methacrylic acid copolymer.

The preferred thickness of the inner surface layer 22 is 30 to 200 μm.

Preferably, the film used as the outer surface layer 24 has good machinability and printability. Examples include films composed of polyester, polyamide, polypropylene, polycarbonate, and polyacetal synthetic resins. These films may be either unoriented films or uniaxially or biaxially oriented films. From the standpoint of printability, a uniaxially or biaxially oriented film is preferably used as the film for the outer surface layer 24.

More specifically, examples include oriented plastic films, such as a biaxially oriented polyethylene terephthalate film, a biaxially oriented polyamide film, and a biaxially oriented polypropylene film. Furthermore, synthetic paper, cellophane, paper, nonwoven fabric, or the like may be used if necessary.

The film used as the outer surface layer 24 may also be an evaporated film having an evaporation layer. The evaporation layer may be formed of an inorganic material such as aluminum, silicon oxide, aluminum oxide, indium oxide, tin oxide, zirconium oxide, or magnesium oxide.

The preferred thickness of the outer surface layer 24 is 12 to 25 μm.

The functional layer may be appropriately selected, depending on the required function, such as gas barrier properties, mechanical strength, flexibility, puncture resistance, impact resistance, wear resistance, cold resistance, heat resistance, or chemical resistance.

Examples of the film used as the functional layer include a metal foil formed of aluminum, iron, copper, or tin; a film formed of polyethylene terephthalate, polyamide, polyvinyl chloride, polycarbonate, polyvinyl alcohol, or ethylene-vinyl acetate copolymer saponifiable matter; a film formed by applying polyvinylidene chloride to the aforementioned films; an evaporated film formed by evaporating an inorganic material, such as aluminum, silicon oxide, aluminum oxide, indium oxide, tin oxide, zirconium oxide, or magnesium oxide; a polyvinylidene chloride film; and a nonwoven fabric or foam film having heat insulating properties.

The number of functional layers may be either one or more than one.

The functional layer may have any thickness as long as it can satisfy the function required for the gusset bag 10, and 6 to 20 μm is preferred.

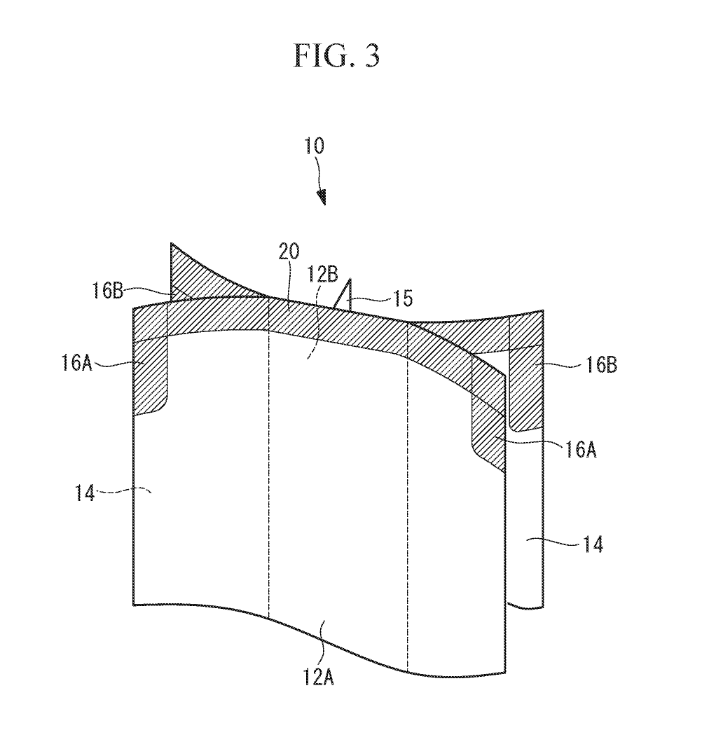

As shown in FIG. 1, the sides of the flat surface part 12A and sides of the side gusset parts 14 are joined together at the inner surfaces thereof, at side heat-sealing portions 16A, serving as the first joint portions. Furthermore, the sides of the flat surface part 12B and the other sides of the side gusset parts 14 are joined at the inner surfaces thereof, at side heat-sealing portions 16B, serving as the second joint portions. FIG. 3 shows a state in which the side heat-sealing portions 16A and 16B are formed in the gusset bag 10.

As is clear from FIGS. 1 and 3, the side heat-sealing portions 16A and 16B join different areas. Specifically, the side heat-sealing portions 16B join together the inner surface layers 22 at different areas from the side heat-sealing portions 16A. In other words, the “different areas” are the other sides (side heat-sealing portions 16B) of the side gusset parts 14, which face the sides of the side gusset parts 14 joined by the side heat-sealing portions 16A.

These side heat-sealing portions 16A and the side heat-sealing portions 16B, facing each other, are joined at the outer surface layer 24, by ultrasonic sealing, at third joint portions (closing sealing portions 18) described below.

In FIGS. 1 and 3, joining at the side heat-sealing portions 16A and 16B is performed in the vicinity of the upper end or in the vicinity of the lower end (not shown) of the gusset bag 10, in the sides of the flat surface parts 12 and the side gusset parts 14. However, the configuration is not limited thereto, and joining at the side heat-sealing portions 16A and 16B may be performed from the upper end to the lower end of the gusset bag 10, in the sides of the flat surface parts 12 and the side gusset parts 14.

Joining at the side heat-sealing portions 16A and 16B is performed by, for example, heat sealing. Joining by heat sealing uses hot plate sealing, in which a heated heat-sealing bar is pressed against the laminated film 21, and then a chilled cooling bar is pressed against the laminated film 21. Because the outer surface layer 24 has heat resistance, areas thereof are not joined by heat sealing for joining the side heat-sealing portions 16A and 16B.

Joining at the side heat-sealing portions 16A and 16B may be performed by another method, such as impulse sealing. Furthermore, if layers constituting the laminated film 21 include a polyvinyl chloride layer or a metal foil layer, high-frequency sealing may be used. Moreover, other joining methods, such as joining by an adhesive, except for ultrasonic sealing, may be used.

In the gusset bag 10 according to the first embodiment, because the pair of flat surface parts 12A and 12B and the pair of side gusset parts 14 are formed by folding a single laminated film 21, basically, the side heat-sealing portions 16A and 16B are unnecessary to function as a bag. However, as will be described in detail below, to close, at the third joint portions, the open side gusset parts 14 at the upper part of the gusset bag 10 while preventing dust from entering the gusset bag 10, joining is performed at the side heat-sealing portions 16A and 16B.

In the gusset bag 10 according to the first embodiment, the laminated film 21 is folded so as to form the flat surface parts 12 and the side gusset parts 14, and the side heat-sealing portions 16A and 16B are formed only in the vicinity of the upper ends of the gusset bag 10. Thus, the side heat-sealing portions 16A and 16B, which are stiff, are not formed at a part held by the user's hand, reducing the pain felt when holding the bag in the hand. However, in the gusset bag 10 in which the flat surface parts 12A and 12B and the side gusset parts 14 are sectioned by folding a single laminated film 21, it is difficult to provide through-holes in the side gusset parts 14 and to align the positions of the through-holes. Therefore, to close the open side gusset parts 14, the method in which the outer surfaces of the first joint portions and second joint portions are joined together at the third joint portions by ultrasonic sealing is suitable.

On the other hand, when the flat surface parts 12 and the side gusset parts 14 formed of different laminated films 21 are joined at the side heat-sealing portions 16A and 16B, with the sides thereof being aligned, the side heat-sealing portions 16A and 16B need to be continuous from the upper end to the lower end of the gusset bag 10 in the sides of the flat surface parts 12 and the side gusset parts 14 to seal the bag, making the right and left ends of the gusset bag 10 stiff.

As has been described above, in the gusset bag 10 according to the first embodiment, at each of the closing sealing portions 18, serving as the third joint portions, the side heat-sealing portion 16A and the side heat-sealing portion 16B are joined at the outer surface of the side gusset part 14. As shown in FIG. 1, joining at the closing sealing portions 18 is performed, for example, in the vicinity of the upper ends and in the vicinity of the lower ends (not shown) of the side gusset parts 14. The closing sealing portions 18 according to the first embodiment have a smaller area than the side heat-sealing portions 16. More specifically, the closing sealing portions 18 are entirely included in the area of the side heat-sealing portions 16.

If the closing sealing portions 18 are not formed, the side gusset parts 14 are open, that is, portions of the outer surfaces thereof are separated. In other words, by means of the closing sealing portions 18, the open upper ends or lower ends of the side gusset parts 14 are closed.

Joining at the closing sealing portions 18 is performed by ultrasonic sealing, which is a method using internal heating. This is because the outer surface layer 24, constituting the outer surfaces of the side gusset parts 14, has heat resistance and is not suited for joining areas thereof by external heating, such as heat sealing.

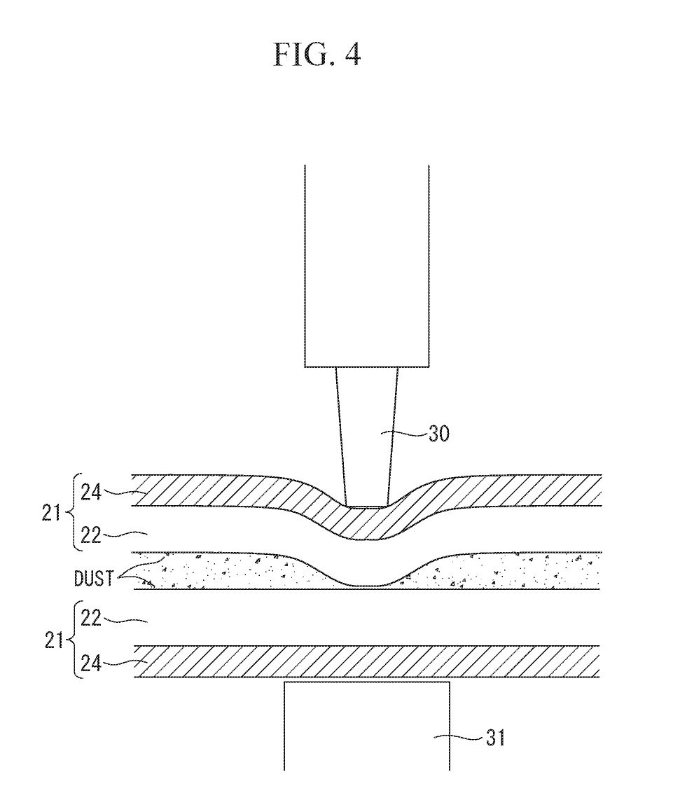

As shown in the example in FIG. 4, the ultrasonic sealing is performed by sandwiching a portion to be joined between an ultrasonic sealing machine 30 and a base 31. Then, the ultrasonic sealing machine 30 is pressed against the portion to be joined, and microvibrations are generated between the laminated films 21 and 21, facing each other, by the ultrasonic wave. By using frictional heat generated by the microvibrations, joining is performed.

To form the closing sealing portions 18 of the gusset bag 10 according to the first embodiment, the side of the gusset bag 10 is sandwiched between the ultrasonic sealing machine 30 and the base 31 and is subjected to ultrasonic sealing. At this time, at the side heat-sealing portions 16A and 16B, the inner surfaces of the flat surface parts 12 and side gusset parts 14 are already joined, at the inner surface layers 22 thereof. Therefore, even when the ultrasonic waves are emitted, the inner surface layers 22 are not relatively displaced in these parts and, hence, do not rub against each other. On the other hand, on the outer surfaces of the side gusset parts 14, only portions of the outer surface layers 24 rub against each other, selectively generating frictional heat by rubbing. Thus, the outer surface layers 24 are joined, forming the closing sealing portions 18.

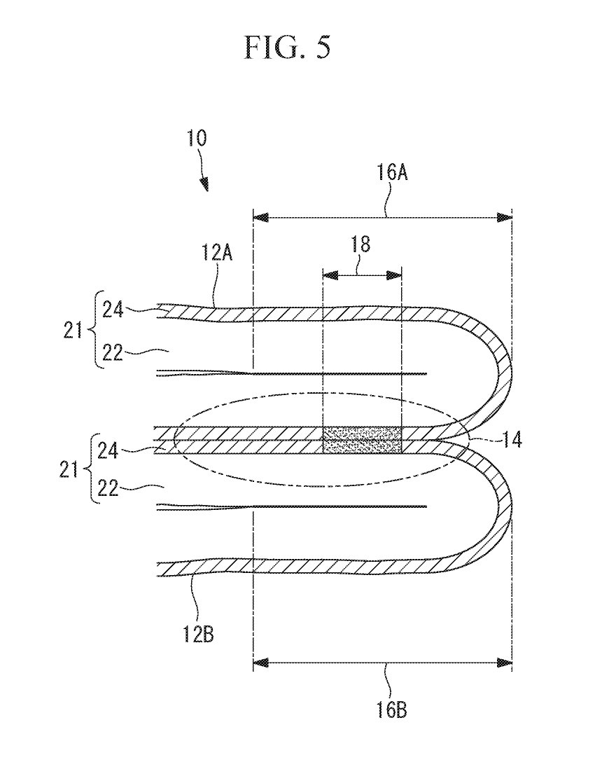

In joining by ultrasonic sealing, two surfaces to be joined are caused to rub against each other, and thus, dust may be produced. However, as shown in FIG. 5, the portions producing dust by the joining at the closing sealing portions 18 are the portions where portions of the outer surfaces of the side gusset parts 14 are caused to rub against each other. These portions where the closing sealing portions 18 are to be formed are on the outside of the gusset bag 10. Therefore, even when the dust is produced due to joining by ultrasonic sealing, because it occurs on the outer surfaces, the dust does not enter the bag.

Herein, the above-described example in FIG. 4 is an example in which the sealant layers, serving as the inner surface layers 22, are joined by ultrasonic sealing. In the case of this type of sealing, the inner surface layers 22 rub against each other, producing dust in the bag. More specifically, if only joining at the closing sealing portions 18 is performed by ultrasonic sealing, without performing joining at the side heat-sealing portions 16A and 16B, although the side gusset parts 14 can be closed, the inner surface layers 22 of the flat surface parts 12 and side gusset parts 14 rub against each other, possibly producing dust in the gusset bag 10.

However, as described above, in the first embodiment, because joining at the side heat-sealing portions 16A and 16B is already performed when the side gusset parts 14 are closed at the closing sealing portions 18, the inner surface layers 22 do not rub against each other in these parts, thus producing no dust. Accordingly, in the gusset bag 10 according to the first embodiment, even when joining by ultrasonic sealing is performed to close the side gusset parts 14, the entry of film pieces or dust into the bag is prevented.

Next, a method for manufacturing the gusset bag 10 according to the first embodiment will be described.

Note that, in the first embodiment, as described above, the pair of flat surface parts 12A and 12B and the pair of side gusset parts 14 are formed of a single laminated film 21 having the base layer, serving as the outer surface layer 24, and the sealant layer, serving as the inner surface layer 22.

First step: The ends of the laminated film 21 paid out from a film roll are joined at the sealant layer thereof such that the sealant layer serves as the inner surface of the gusset bag 10. As a result of this joining, the back-closure heat sealing portion 15 is formed, making the laminated film 21 a tubular member. Joining at the back-closure heat sealing portion 15 is performed by, for example, heat sealing.

Second step: Sections to constitute the side gusset parts 14 are folded to the inside of the tubular member.

Third step: The upper end opening of the tubular member is closed by, for example, heat sealing, forming the end-opening sealing portion 20.

Fourth step: The side heat-sealing portions 16A and 16B are formed at the sides of the flat surface parts 12, in the upper or lower part of the tubular member (see FIG. 3).

Fifth step: The closing sealing portions 18 are formed in the areas of the side heat-sealing portions 16A and 16B, that is, so as to be included in the areas of the side heat-sealing portions 16A and 16B, closing the side gusset parts 14 (see FIG. 1).

Note that the fourth step may be performed after the second step, and the third step may be performed after the fourth and fifth steps.

As has been described above, the gusset bag 10 according to the first embodiment consists of the pair of flat surface parts 12A and 12B facing each other, and the side gusset parts 14, which are folded to the inside of the bag. The gusset bag 10 has the side heat-sealing portions 16A at which the sides of the flat surface parts 12A and sides of the side gusset parts 14 are joined at the inner surfaces thereof, and the side heat-sealing portions 16B at which the sides of the flat surface parts 12B and the other sides of the side gusset parts 14 are joined at the inner surfaces thereof. Moreover, the gusset bag 10 has the closing sealing portions 18, at each of which the side heat-sealing portion 16A and the side heat-sealing portion 16B are joined at the outer surface of the side gusset part 14 by ultrasonic sealing.

With this configuration, in the gusset bag 10 according to the first embodiment, even when joining at the outer surfaces of the side gusset parts 14 is performed by ultrasonic sealing, because the inner surfaces of the bag are already joined at the side heat-sealing portions 16A and 16B, the inner surfaces of the gusset bag 10 do not rub against each other, producing no dust. Accordingly, with the gusset bag 10 according to the first embodiment, it is possible to easily close the side gusset parts 14, while preventing film pieces or dust from entering the bag, in the step of closing the side gusset parts 14. Furthermore, the gusset bag 10 having the side gusset parts 14 has good appearance, and, even if the gusset bag 10 is dropped by accident, rupturing of the bag is suppressed.

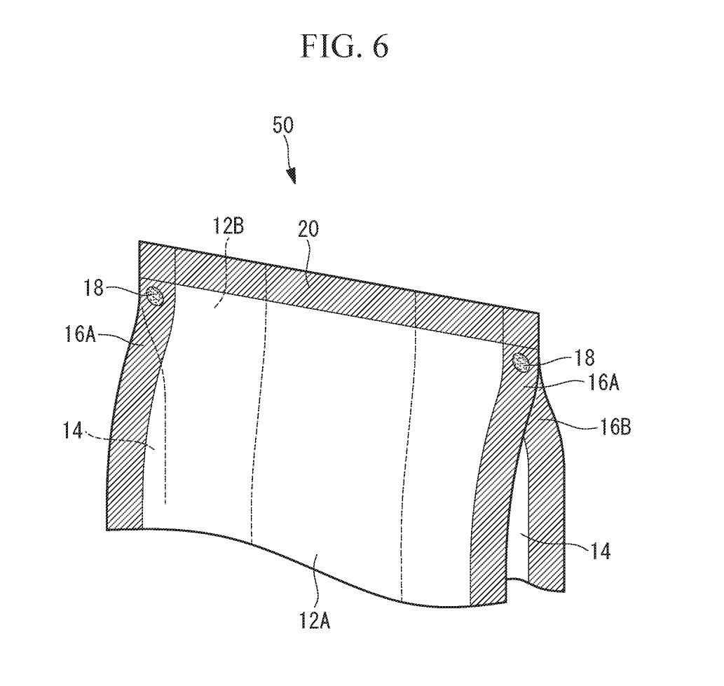

FIG. 6 is a perspective view showing the upper part of a gusset bag 50, which is another example of the first embodiment, in which the respective parts are formed of different laminated films 21. Specifically, in the gusset bag 50 in FIG. 6, the pair of flat surface parts 12A and 12B are each formed of a single laminated film 21, and the pair of side gusset parts 14 are each formed of a single laminated film 21.

In this example, as shown in FIG. 6, the side heat-sealing portions 16A and 16B are formed so as to extend from the top to the bottom of the gusset bag 50.

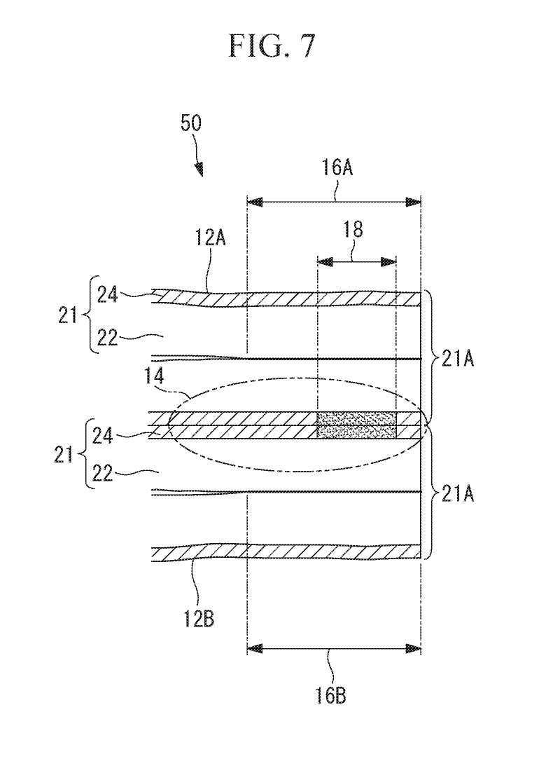

FIG. 7 is a lateral cross-sectional view corresponding to FIG. 6, showing the side heat-sealing portions 16A and 16B in a partially enlarged state.

As shown in FIG. 7, because the respective parts of the gusset bag 50 are formed of different laminated films 21, the ends of the side gusset parts 14 are cut surfaces 21A, not curved surfaces as in the case of the gusset bag 10, which is formed of a single laminated film 21 (see FIG. 5).

Alternatively, the flat surface part 12A and the pair of side gusset parts 14 may be formed of a single laminated film 21, and the flat surface part 12B may be formed of another laminated film 21.

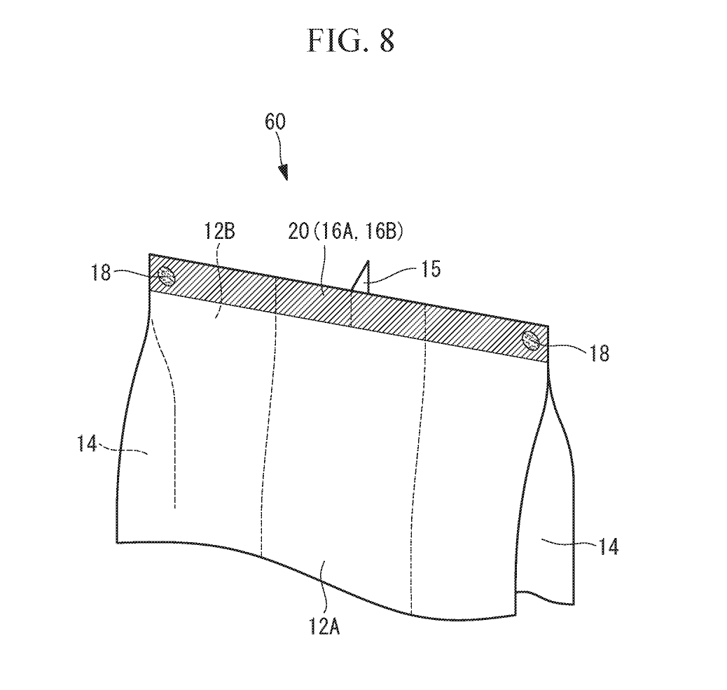

In the first embodiment illustrated in FIGS. 1 and 6, although the examples in which the closing sealing portions 18 are formed in the side heat-sealing portions 16A and 16B, serving as the first joint portion and the second joint portion, have been shown, the configuration is not limited thereto, and, as in a gusset bag 60 shown in FIG. 8, the sides of the end-opening sealing portion 20 may be regarded as the first joint portion and the second joint portion, and the closing sealing portions 18 may be formed in the end-opening sealing portion 20. In the example in FIG. 8, the areas of the first joint portion and the second joint portion, in which the closing sealing portions 18, serving as the third joint portions, are provided, are provided so as to overlap the end-opening sealing portion 20.

### Second Embodiment

A second embodiment of the present invention will be described below.

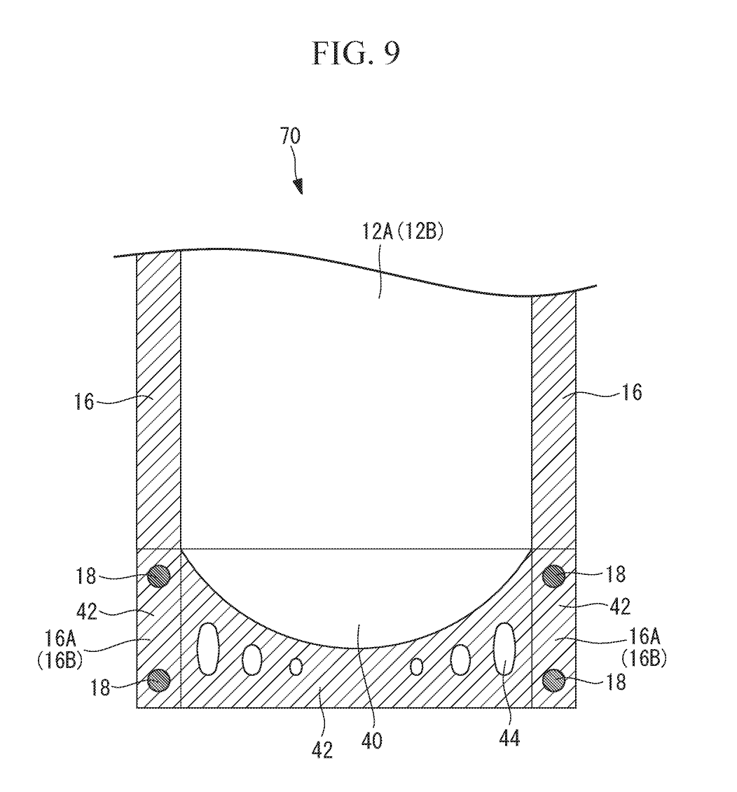

FIG. 9 is a front view of a gusset bag 70 according to the second embodiment. In FIG. 9, the components the same as those in FIG. 1 are denoted by the same reference signs as in FIG. 1, and the descriptions thereof will be omitted.

The gusset bag 70 according to the second embodiment consists of a pair of flat surface parts 12A and 12B and a bottom gusset part 40. The bottom gusset part 40 is formed so as to be folded inward, between the pair of flat surface parts 12A and 12B, at the lower part of the pair of flat surface parts 12A and 12B. The hatched section is a section in which the laminated films 21 constituting the gusset bag 70 are joined.

The flat surface parts 12A and 12B and the bottom gusset part 40 are joined at the inner surfaces thereof, at lower heat sealing portions 42, in the lower part of the gusset bag 70.

Furthermore, at the sides of the gusset bag 70, the opposed inner surfaces at the sides of the flat surface parts 12A and 12B are joined at the side heat-sealing portions 16, the opposed inner surfaces at the sides of the flat surface parts 12A and sides of the bottom gusset part 40 are joined at the side heat-sealing portions 16A, and opposed inner surfaces at the sides of the flat surface parts 12B and the other sides of the bottom gusset part 40 are joined at the side heat-sealing portions 16B. Herein, the side heat-sealing portions 16 and the side heat-sealing portions 16A are continuous, and the side heat-sealing portions 16 and the side heat-sealing portions 16B are continuous. The side heat-sealing portions 16A, at which the sides of the flat surface parts 12A and the sides of the bottom gusset part 40 are joined at the inner surfaces thereof, serve as first joint portions, and the side heat-sealing portions 16B, at which the sides of the flat surface parts 12B and the other sides of the bottom gusset part 40 are joined at the inner surfaces thereof, serve as second joint portions. Furthermore, the lower heat sealing portions 42 may be formed as a vessel-shaped heat sealing portion that is integral with the side heat-sealing portions 16A and 16B. In the vessel-shaped heat sealing portion, unsealed portions 44, which are unjoined portions, are appropriately provided in the lower heat sealing portions 42. Joining at the lower heat sealing portions 42 and at the side heat-sealing portions 16A and 16B is performed by, for example, heat sealing. Because the joining by heat sealing is the same as that in the first embodiment, the description thereof will be omitted.

Herein, in a state in which only joining at the side heat-sealing portions 16A and 16B is performed, the bottom gusset part 40 is open at the side heat-sealing portions 16A and 16B.

To provide a free-standing property by closing the open bottom gusset part 40, areas of the bottom gusset part 40 are joined together at the outer surface thereof, at the closing sealing portions 18, which are sealed by ultrasonic sealing, such that the closing sealing portions 18 are included in the areas of the side heat-sealing portions 16A and 16B. The closing sealing portions 18 are third joint portions. Because the joining by ultrasonic sealing is the same as that according to the first embodiment, the description thereof will be omitted.

Even when the bottom gusset part 40 is closed at the outer surface thereof, at the closing sealing portions 18, because joining at the side heat-sealing portions 16A and 16B is already performed, the inner surfaces of the flat surface parts 12A and the bottom gusset part 40 and the inner surfaces of the flat surface parts 12B and the bottom gusset part 40 do not rub against each other in these parts. Accordingly, in the gusset bag 70 according to the second embodiment, even when joining by ultrasonic sealing is performed to close the bottom gusset part 40, the entry of film pieces or dust into the bag is prevented.

Although the closing sealing portions 18 only need to be provided, one on the right and one on the left, at positions where the side heat-sealing portions 16A and 16B overlap the bottom gusset part 40, the configuration is not limited thereto. For example, as shown in FIG. 9, depending on the size of the gusset bag 70, a plurality of closing sealing portions 18 may be provided in the vertical direction of the gusset bag 70.

As has been described above, in the gusset bag 70 according to the second embodiment, areas of the bottom gusset part 40 are joined together at the outer surface thereof, at the closing sealing portions 18, such that the closing sealing portions 18 are included in the areas of the side heat-sealing portions 16A and 16B, at which the flat surface parts 12A and 12B and the bottom gusset part 40 are joined.

With this configuration, in the gusset bag 70 according to the second embodiment, even when joining at the closing sealing portions 18 is performed by ultrasonic sealing, because the inner surfaces of the flat surface part 12A and the bottom gusset part 40 and the inner surfaces of the flat surface part 12B and the bottom gusset part 40, constituting the inside of the bag, are already joined at the side heat-sealing portions 16A and 16B, the inner surfaces of them do not rub against each other, thus producing no dust. Accordingly, in the gusset bag 70 according to the second embodiment, it is possible to easily close the bottom gusset part 40, while preventing dust from entering the gusset bag 70, in the step of closing the bottom gusset part 40. Hence, it is possible to improve the free-standing property of the gusset bag 70 having the bottom gusset part 40.

### Third Embodiment

A third embodiment of the present invention will be described below.

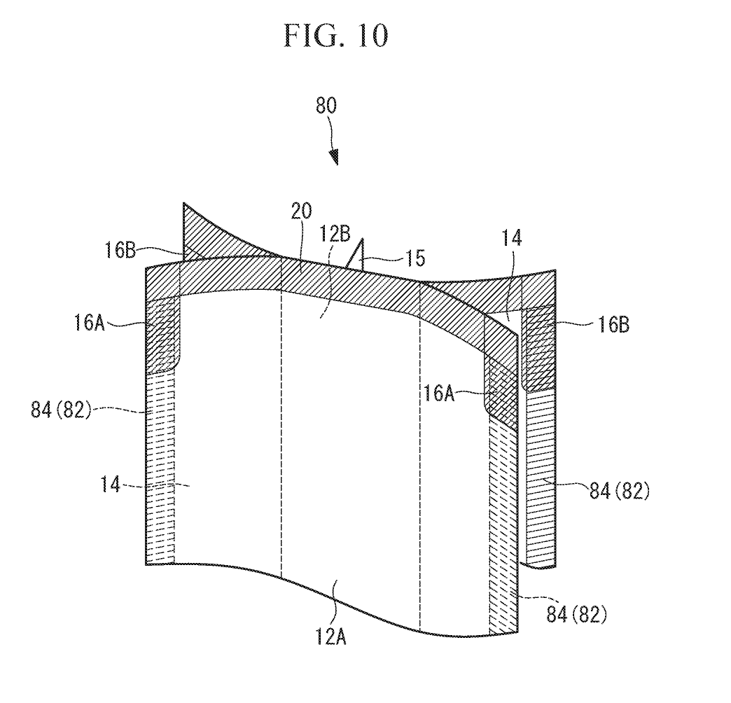

FIG. 10 is a perspective view showing the upper part of a gusset bag 80 according to the third embodiment. In FIG. 10, the components the same as those in FIG. 3 are denoted by the same reference signs as in FIG. 3, and the descriptions thereof will be omitted.

In the gusset bag 80 according to the third embodiment, concavo-convex patterns 82 are formed in joining surfaces of the closing sealing portions 18.

In the gusset bag 80 according to the third embodiment, as shown in FIG. 10, the concavo-convex patterns 82 are formed in the areas (hereinbelow referred to as “concavo-convex forming areas”) 84 including portions, in the outer surfaces of the side gusset parts 14, to be joined at the closing sealing portions 18. Because the concavo-convex forming areas 84 are provided so as to overlap the closing sealing portions 18, the concavo-convex forming areas 84 also overlap the side heat-sealing portions 16A and 16B.

Furthermore, in the example in FIG. 10, the concavo-convex forming areas 84, in which the concavo-convex patterns 82 are formed, are uniformly provided, from substantially the top to the bottom, at the sides of the side gusset parts 14. However, the configuration is not limited thereto, and the concavo-convex forming areas 84 only need to include at least portions to be joined at the closing sealing portions 18 and, hence, may be provided only in parts of the sides of the side gusset parts 14.

Furthermore, in the example in FIG. 10, although the concavo-convex forming areas 84 are provided on both of the outer surfaces to be joined at the closing sealing portions 18, the configuration is not limited thereto, and the concavo-convex forming area 84 may be provided on one of the outer surfaces (side heat-sealing portions 16A and 16B) to be joined at the closing sealing portions 18.

The concavo-convex patterns 82 are, for example, a rough surface or slits.

The rough surface is, for example, a surface having fine dot-like scratches, and a large number of such scratches are formed at equal intervals or randomly.

The slits are linear scratches, and a large number of such scratches, either in a continuous form (a straight-line shape) or a discontinuous form (a perforated-line shape), are formed in parallel. More specifically, a large number of linear scratches, formed so as to extend in the horizontal direction of the side gusset parts 14, may be formed in parallel in the vertical direction, or a large number of linear scratches, formed so as to extend in the vertical direction of the side gusset parts 14, may be formed in parallel in the horizontal direction. Furthermore, for example, a plurality of cross-shaped or X-shaped slits may be formed.

The concavo-convex patterns 82 may have a shape other than the rough surface or the slits described above.

The rough surface is formed by, for example, pressing a file, abrasive grains, a roll provided with concavo-convex portions on the surface thereof, or the like against the concavo-convex forming areas 84. Furthermore, the slits are formed by, for example, urging metal needle, blade, or the like. Moreover, other than these methods, the rough surface or slits may be formed by another method, such as laser machining using carbon dioxide gas laser or the like, the use of wire brush, or the like.

As has been described above, in the gusset bag 80 according to the third embodiment, after the concavo-convex patterns 82 are formed in the joining surfaces of the closing sealing portions 18, joining at the closing sealing portions 18 is performed by ultrasonic sealing.

By forming the concavo-convex patterns 82 in the joining surfaces of the closing sealing portions 18, the surface area of the closing sealing portions 18 increases, which increases the frictional resistance caused by the ultrasonic sealing. Accordingly, compared with the case where the concavo-convex patterns 82 are not formed, the gusset bag 80 according to the third embodiment has higher joining strength at the closing sealing portions 18 and can suppress subsequent separation of the sealed closing sealing portions 18.

Furthermore, the concavo-convex patterns 82 may or may not be provided so as to penetrate through the outer surface layer 24.

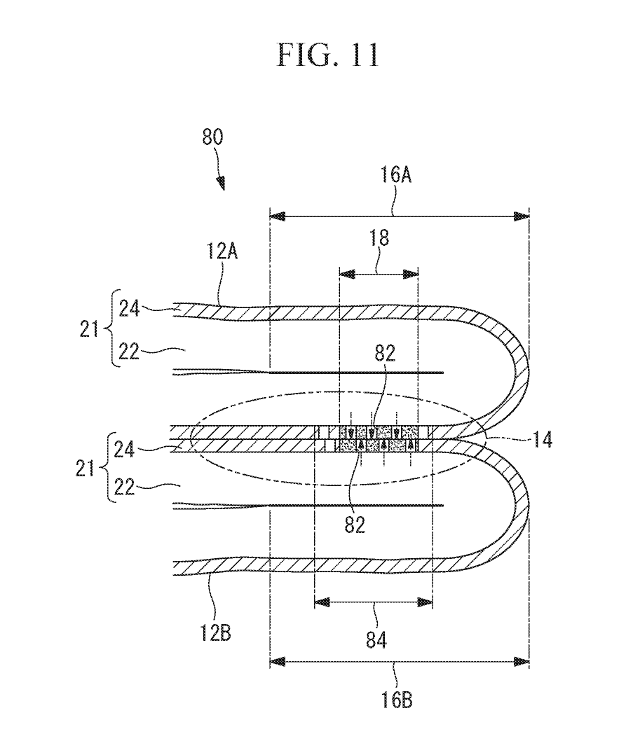

FIG. 11 is a lateral cross-sectional view showing, in a partially enlarged state, the side heat-sealing portions 16A and 16B according to the third embodiment, in which the closing sealing portion 18 having the concavo-convex pattern 82, which penetrates through the outer surface layer 24, is shown.

If the concavo-convex pattern 82 penetrates through the outer surface layer 24 and reaches the inner surface layer 22, as shown by arrows in FIG. 11, the resin that forms the inner surface layer 22 (sealant layer) permeates to the outer surface layer 24 through through-holes formed in the concavo-convex pattern 82. The resin that forms the inner surface layer has a heat-sealing property. Therefore, when joining at the closing sealing portions 18 is performed, the resin permeated to the outer surface layer 24 contributes to the sealing (heat sealing) by frictional heat, thus further increasing the joining strength at the closing sealing portions 18.

The larger the width (diameter) of each scratch constituting the concavo-convex pattern 82 is, the more resin of the inner surface layer 22 permeates out, increasing the joining strength achieved by heat sealing of the resin, but the joining strength achieved by the concavo-convex pattern 82 decreases relatively. On the other hand, the smaller the width of each scratch constituting the concavo-convex pattern 82 is, the less resin permeates out, decreasing the joining strength achieved by heat sealing of the resin, but the joining strength achieved by the concavo-convex pattern 82 increases relatively.

Therefore, when the concavo-convex pattern 82 is formed so as to penetrate through the outer surface layer 24, it is preferable that the width of the scratch be determined by taking the balance between the joining strength achieved by heat sealing of the resin and the joining strength achieved by the concavo-convex pattern 82 into consideration.

Furthermore, when the laminated film 21 constituting the gusset bag 80 includes a functional layer, serving as an intermediate layer having no heat-sealing property, between the outer surface layer 24 and the inner surface layer 22, the concavo-convex pattern 82 may penetrate through the outer surface layer 24 and the intermediate layer, and the through-holes may reach the inner surface layer 22.

Although the present invention has been described above by using the above-described embodiments, the technical scope of the present invention is not limited to the scopes described in the above embodiments. The above-described embodiments may be variously modified or improved within a scope not departing from the scope of the invention, and such modified or improved configurations are also included in the technical scope of the present invention.

For example, in the above-described embodiments, although the configurations in which the entire closing sealing portions 18 are included in the areas of the side heat-sealing portions 16A and 16B or in the area of the lower heat sealing portions 42 have been described above, the present invention is not limited thereto, and a configuration in which the closing sealing portions 18 are partially included in the areas of the side heat-sealing portions 16A and 16 or in the area of the lower heat sealing portions 42B is also possible.

Furthermore, in the above-described embodiments, a plurality of closing sealing portions 18 may be provided in the side heat-sealing portions 16A and 16B.

Furthermore, in the above-described embodiments, the outer surfaces of the gusset bags 10, 50, 60, 70, and 80 may have a heat-sealing property to enable joining by heat sealing or the like.

Furthermore, in the above-described embodiments, the gusset bags 10, 50, 60, 70, and 80 may be provided with a spout through which the contents are poured out.

### REFERENCE SIGNS LIST

10, 50, 60, 70, 80: gusset bag
12: flat surface part
14: side gusset part
16A: side heat-sealing portion
16B: side heat-sealing portion
18: closing sealing portion
21: laminated film
22: inner surface layer
24: outer surface layer
82: concavo-convex pattern

1. A gusset bag comprising:
a pair of flat surface parts facing each other;
a gusset part that is folded to the inside of the bag;
a first joint portion at which a side of one flat surface part and a side of the gusset part are joined at the inner surfaces thereof;
a second joint portion at which a side of the other flat surface part and the other side of the gusset part are joined at the inner surfaces thereof; and
a third joint portion at which the first joint portion and the second joint portion are joined together at the outer surface of the gusset part by ultrasonic sealing.

2. The gusset bag according to claim 1, wherein the pair of flat surface parts and the gusset part are formed by folding a film into sections.

3. The gusset bag according to claim 1, wherein the pair of flat surface parts are each formed of a single film, and the gusset part is formed of a single film.

4. The gusset bag according to claim 1, wherein the gusset part is a side gusset part or a bottom gusset part.

5. The gusset bag according to claim 1, wherein a concavo-convex pattern is formed on a joining surface of the third joint portion.

6. A method for manufacturing a gusset bag having a pair of flat surface parts facing each other and a gusset part folded to the inside of the bag, the method comprising:
joining a side of one flat surface part and a side of the gusset part at the inner surfaces thereof at a first joint portion;
joining a side of the other flat surface part and the other side of the gusset part at the inner surfaces thereof at a second joint portion; and
forming a third joint portion by joining the first joint portion and the second joint portion at the outer surface of the gusset part by ultrasonic sealing.

7. A method for joining laminated members each formed by laminating a first layer having a heat-sealing property and a second layer having heat resistance, in which the second layers are joined together, the method comprising:
joining the first layers at a first joint portion;
joining the first layers at a second joint portion in a different area from the first joint portion, and
joining the first joint portion and the second joint portion at the second layers thereof by ultrasonic sealing, forming a third joint portion.
